(19) United States
(12) Patent Application Publication
(10) Pub. No.: US 2009/0171924 A1
(43) Pub. Date: Jul. 2, 2009

(54) Auto-complete search menu

(76) Inventors: Michael Patrick Nash, Saskatoon (CA); Ryan Scott Breidenbach, Coppell, TX (US); Roderick F. Coffin, III, Dallas, TX (US); Kelly Christopher Fox, Austin, TX (US); Ben Rady, Dallas, TX (US); Daniel L. James, Annetta, TX (US); Paul Randolph Holser, JR., Addison, TX (US); Ruby Bailey, McKinney, TX (US); Craig Walls, Plano, TX (US)

Correspondence Address: Steven Thrasher, 391 Sandhill Dr., Richardson, TX, 75080, US

(21) Appl. No.: 12/079,879

(22) Filed: Mar. 29, 2008

Related U.S. Application Data
(60) Provisional application No. 61/009,815, filed on Jan. 2, 2008.

(51) Int. Cl. G06F 17/30

(52) U.S. Cl. 707/4; 707/E17.015

(57) ABSTRACT

The invention builds a natural-language query by associating a auto-complete menu system with a domain-specific concept model, generating a command displayed in a list of proper commands, in a auto-complete fashion to the user (the list of proper commands comprising all elements of a set of proper commands), detecting a command choice of the user, and displaying the command choice in the entry area upon determining that the command choice is a proper command, and generating a target concept in a similar manner. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATION

The invention is related to and claims priority from pending U.S. Provisional Patent Application No. 61/009,815 to Lane, et al., entitled NATURAL LANGUAGE DATABASE QUERYING filed on 2 Jan. 2008.

### TECHNICAL FIELD OF THE INVENTION

The present invention relates generally to structured data querying, and more particularly to natural language database querying.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Database querying is generally limited to structured queries. Recently, attempts have been made to generate “natural language” queries, however, these “solutions” involve a significant amount of menu-driven selecting of terms and relations to guide a user to ask the “right” question. This solution is burdensome, and entirely unsatisfactory to most users. The present invention solves the problem of time-consuming menu-driven database querying.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is an exemplary concept model.

FIG. 2 illustrates the MEGP syntax.

FIG. 3 is a second exemplary concept model.

FIGS. 4a-4f which illustrate the building of a natural-language query via the auto-complete menu system.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Computing platforms are computers, such as personal computers, workstations, servers, or sub-systems of any of the aforementioned devices. Further, a computing platform may be segmented by functionality into a first computing platform, second computing platform, etc. such that the physical hardware for the first and second computing platforms is identical (or shared), where the distinction between the devices (or systems and/or sub-systems, depending on context) is defined by the separate functionality which is typically implemented through different code (software).

Of course, the foregoing discussions and definitions are provided for clarification purposes and are not limiting. Words and phrases are to be given their ordinary plain meaning unless indicated otherwise.

This discussion incorporates the teaching of co-pending and co-owned U.S. patent application Ser. No. 11/___,___ to Lane, et al. filed on 31 Jan. 2008, entitled NATURAL LANGUAGE MINIMALLY EXPLICIT GRAMMAR PATTERN, as well as co-pending and co-owned U.S. patent application Ser. No. 11/___,___ to Lane, et al. filed on 31 Jan. 2008, entitled DOMAIN-SPECIFIC CONCEPT MODEL FOR ASSOCIATING STRUCTURED DATA THAT ENABLES A NATURAL LANGUAGE QUERY, both of which are incorporated herein by reference in their entirety.

### DESCRIPTION OF THE DRAWINGS

An auto-complete menu is in one aspect a system for assisting a user in expressing what a user intends to find as the result of a database inquiry such that ambiguity is removed from the query. Stated another way, functionally, while a Minimally Explicit Grammar Pattern (MEGP) is a compromise between entering a true natural language query, and having to either type a structured query and/or use a menu-driven query system, an auto-complete menu system assist a user in creating a proper, error-free query. As a system, MEGP defines a syntax and set of words that are a subset of a user's natural language, and which map to known concepts, values, logical relationships, relations, and/or comparitors. Of course, it is understood that those terms used herein are readily apparent and understood by those skilled in the art of conceptual databases upon reading this disclosure.

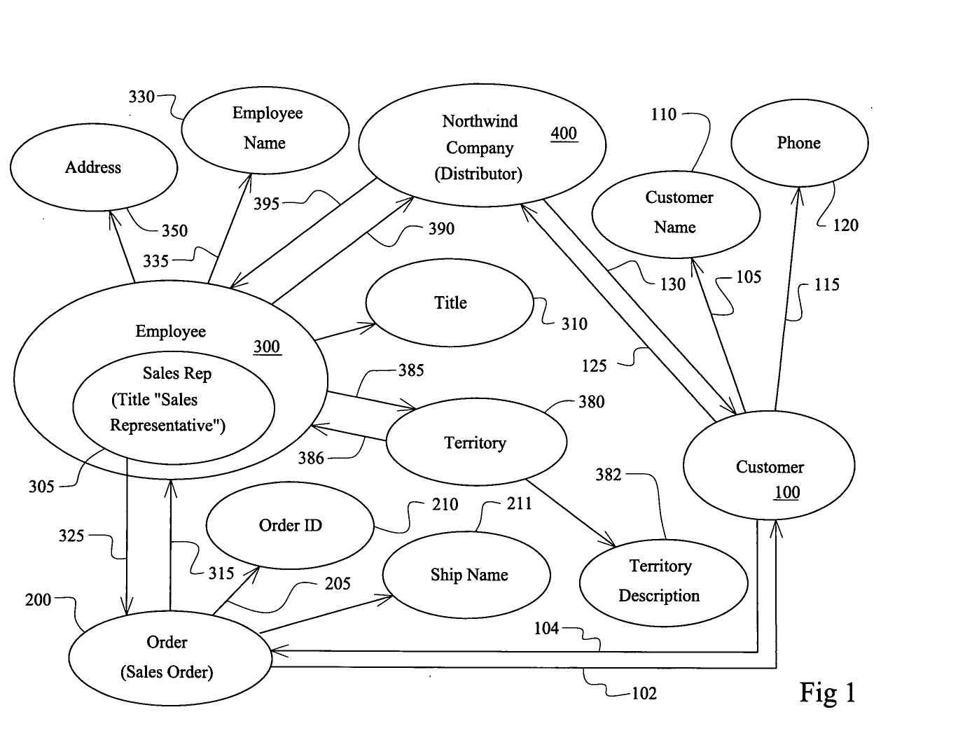

FIG. 1 is an exemplary concept model. The concept model comprises a customer concept 100, an order concept 200, a company concept 400, and an employee concept 300 that wholly includes a sales rep property 305. The customer concept 100 is related to property “customer name” 110 by relation “named” 105, and property phone 120 by relation “having phone” 115. Customer concept 100 is related to company concept 400 by the “buys from” relation and the “sells to” reverse relation, as well as the order concept 200 via the “who placed” relation 104 and the “placed by” 102 reverse relation. Order concept 200 is related to the “order ID” property 210 via the “having ID” relation 205. Further, the order concept 200 is related to both the employee concept 300 and the “sales rep” property 305 via the “written by” relation 315 and the “who wrote” reverse relation 325.

The employee concept 300 is related to the company concept 400 via an “employed by” relation 390 and an employs relation 395 (which is a reverse-relation of the “employed by” relation 390). In addition, the employee concept 300 includes an “employee name” property 330 related by a “having name” relation 335, and an address external abstraction 350 related by the “working at address” relation 355.

The employee concept 300 is further related to a territory attribute 380 via an “assigned to” relation 385 and a second “assigned to” reverse concept 386. The territory attribute 380 is further related to a “territory description” property 382 via a “named” relation 383.

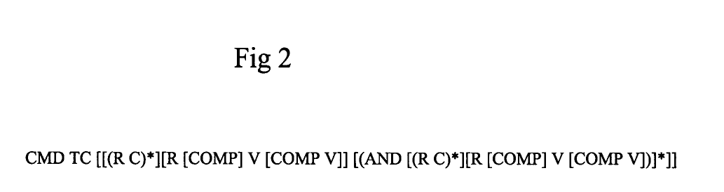

FIG. 2 illustrates the MEGP syntax. This syntax is part-and-parcel to a methodology of providing a user the ability to find specific data, without ambiguity, using a subset of that user's natural language in a subject area. In describing the methodology of entering a query using the MPEG syntax, reference is made to Table 1, below, which is a legend of the MPEG syntax nomenclature. It should be noted that the employment of synonyms is provided in the MEGP model, and the incorporation of synonyms is indicated in the following table as indicated by the “#” symbol.

TABLE 1
LEGEND OF MPEG SYNTAX NOMENCLATURE.

| ABBREVIATION/ | |
|---|---|
| SYMBOL | REPRESENTATION |
| CMD | Command. Example: “list”, “count”. # |
| TC | Target Concept. Single or multi-word; |
| | columns & rows returned for TC only. # |
| C | Concept. May be a Specialized Concept. # |
| V | Value. Exact match of one or more words (not |
| | case sensitive). |
| AND | The literal word “AND” or equivalent |
| | conjunction; not case sensitive. |
| R | Relation. Exact match of one or more words. |
| | Directionally unique for each concept. # |
| COMP | Comparitor. Ex) dates, “since”, “after”, |
| | “before”, “through”, “on”, “from/to”. <> =. # |
| [ ] | That which within is OPTIONAL. |
| * | Repeat. |

### General Methodology

Before discussing a specific MPEG, one should consider the invention from a “high”/generic level. One embodiment of the inventive method begins when a database query is begun when a computer system accepts an input comprising words (and, in some cases only words), where the input is restricted to a predefined syntax comprising a predefined set of words, in a known order, from a first known subject area, and an answer comprising a datum is generated in response to that database inquiry. The methodology preferably seeks to avoid returning “garbage” by validating that the input matches an expected structure before running any query on a target data source. Where a conceptual data model is employed, the method maps the words to a conceptual inquiry.

### More Specific MPEG Query Methodology

With more particular reference to FIG. 2, one embodiment of the invention can be recognized as a method for providing a user the ability to find specific data without ambiguity using a subset of that user's natural language in a subject area. Here, a user enters a search that locates structured data in a database, where the search “grammar” is predefined, here particularly to include mandatory elements comprising a command (such as “find”) and a target concept (such as “sales”), and a set of optional elements comprising at least either a relationship R (such as “exact match”) or a value V (such as ‘X’) having a comparitor such as “equal to ______.”

Accordingly, a command CMD may define an output type, such as “list”, “show”, “table” or “print.” The target concept TC is the first concept chosen, and is selected from a group of concepts, the group of concepts being predefined associations of sets of data. In addition, a relation R defines how a concept is related to either a value, comparitor or another concept. Thus, the relationship “R” is in one embodiment associated with a comparitor, or in other words, a relationship “R” is associated with a value “V” via a comparator. Similarly the value “V” may be associated directly with a comparitor (“equal to 1000”). Similarly, the comparitor may be associated with a second value “V.” Comparators may also define a mathematical, spatial, temporal, or logical relationship. The set of optional elements may include a second relationship “R” and a concept “C” related to the second relationship. Further, as is indicated by brackets “[ ]” in FIG. 2, the grammar may include additional optional elements and optional sets of elements, such as a second set of optional elements, or even a third relationship and a concept related to the third relationship. In the preferred embodiment, the second set of optional elements comprises a relationship and a concept.

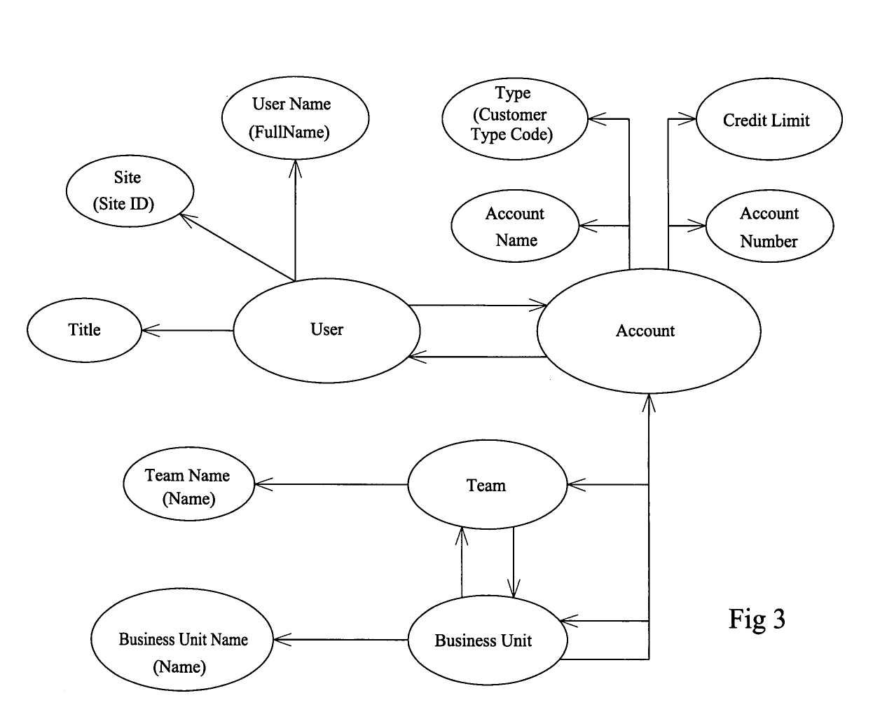

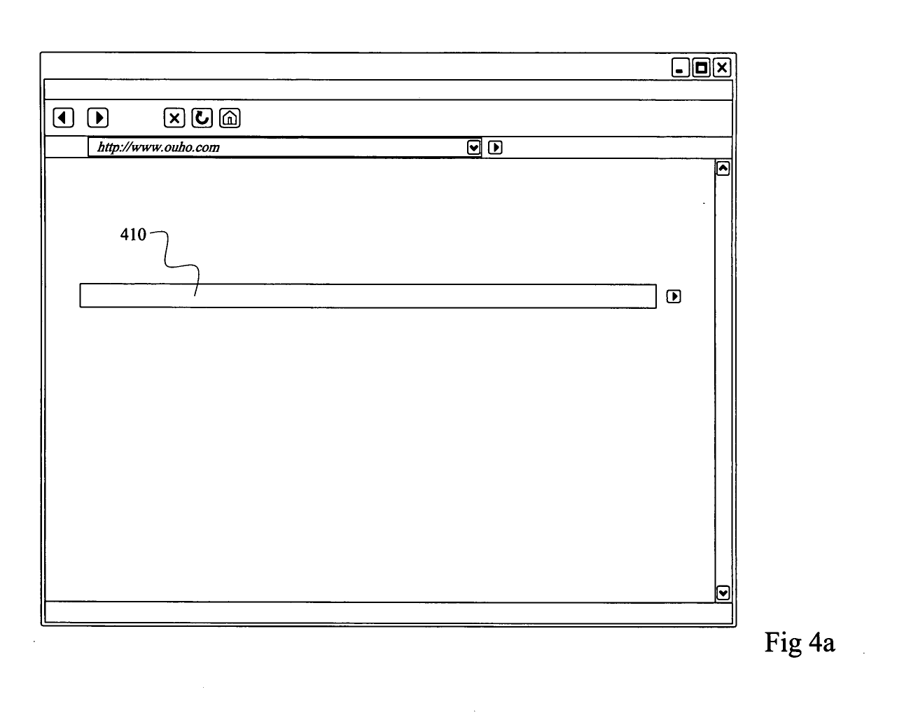

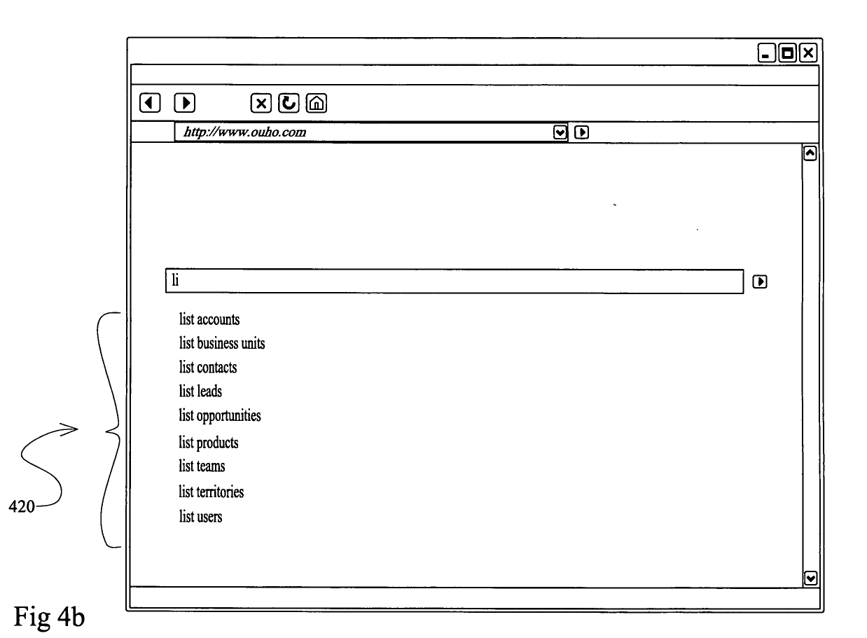

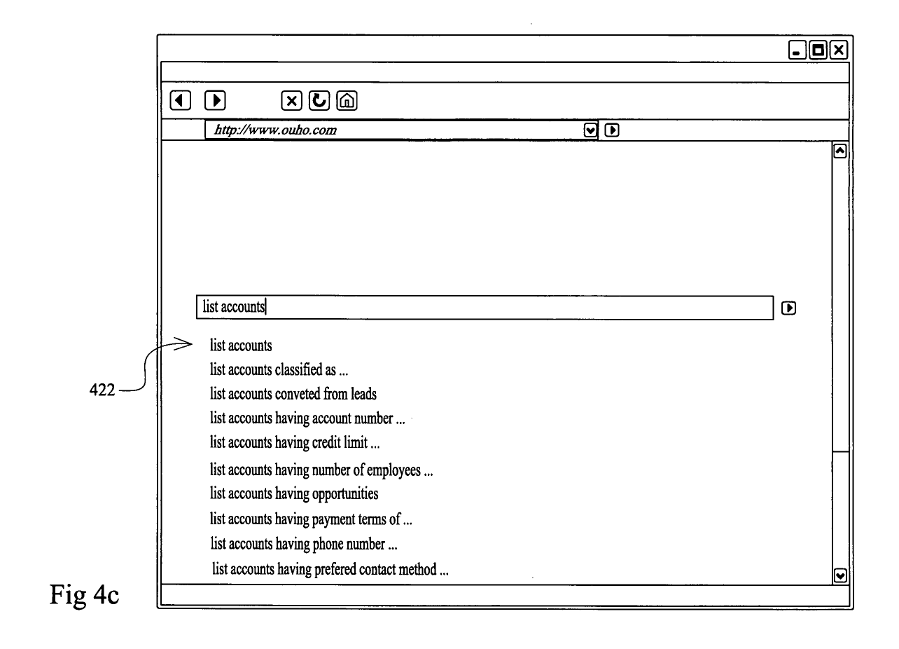

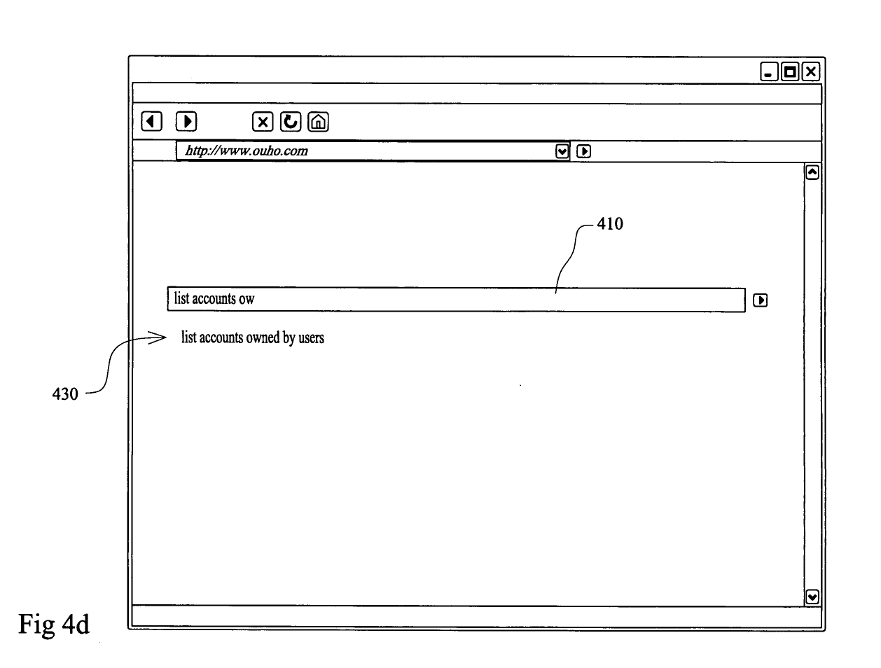

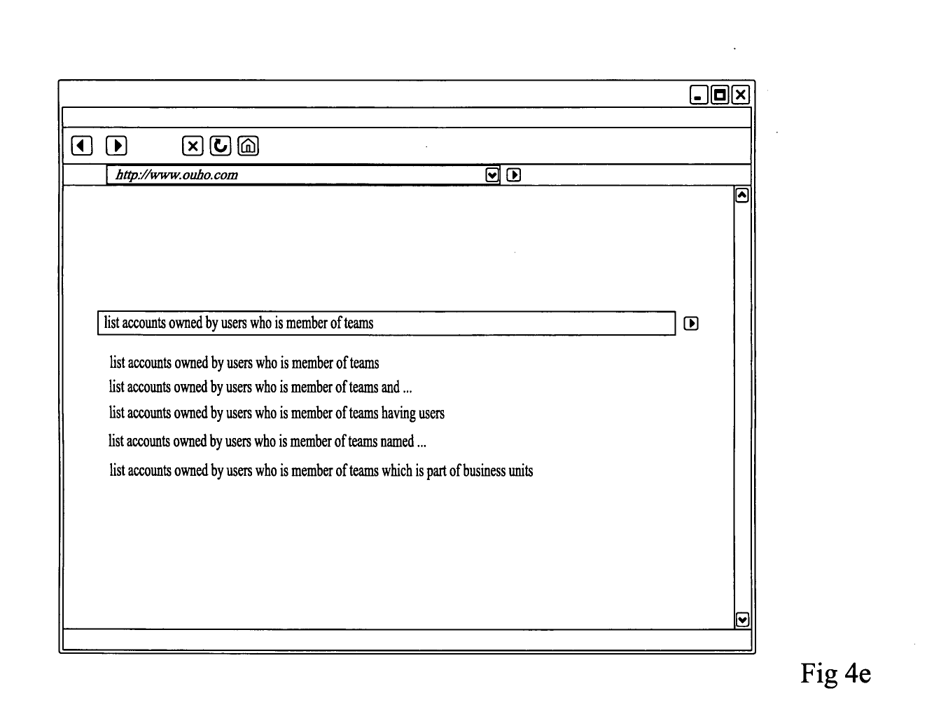

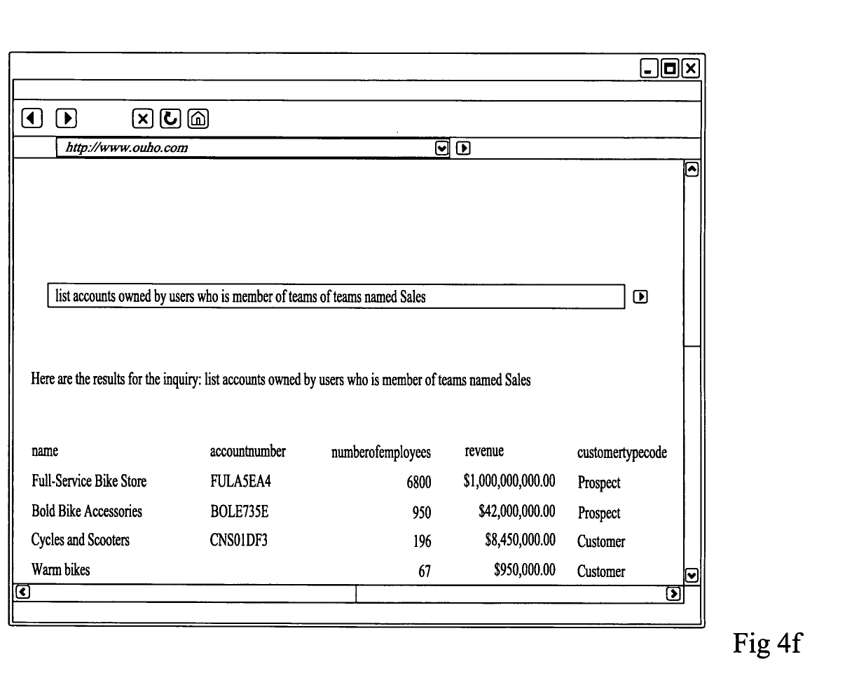

The following discussion makes simultaneous reference to FIG. 3 which is a second exemplary concept model, and FIGS. 4a-4X which illustrate the building of a natural-language query via the auto-complete menu system according to the present invention. Specifically, FIG. 3 is a concept map of a portion of a Microsoft® customer relationship management (CRM) model developed by and available from Semantra® of Addison, Tex. It is understood that when referring to FIG. 3 that because a complete concept map of the MS® CRM is too voluminous to provide herein, and because only a portion of such concept map is needed to understand the invention, only a small portion of the concept map is being shown to illustrate the teachings of the invention, and references below made to concepts not shown in FIG. 3 are unnecessary for the understanding of the invention, but could incorporate these inventive teachings.

FIGS. 4a-4f which illustrate the building of a natural-language query via the auto-complete menu system. In particular, FIG. 4a illustrates a query-entry text-entry box 410. The text-entry box 410 thus defined to allow a user to mouse-select the box 410 for text-entry. However, when a user begin to enter text by selecting the text-entry box 410, a list of commands drop-down as shown in FIG. 4b. The list of commands drop-down 420 comprises all valid available commands, and may also include a listing of all valid concepts, objects, properties, etc. as designated by the then-relevant database. It should be noted that while the list includes all available commands consistent with the typing and/or synonyms and spelling corrections, it should be understood that the list at any given time will be limited to showing those items that can be shown in both an order and in readable font-sizes, such that a user may “scroll” through valid commands and other word choices. As shown in FIG. 4c, the user has selected the “list” command and the “accounts” concept 422. This information appears as selected information in the text-entry box 410. All the while, note that these user selection and text selection options precisely track the concept model of FIG. 3.

Continuing, FIG. 4d illustrates that following the user selection of “list accounts”, the user is continuing to enter “ow . . . ” in the text box 410. This elicits the invention to suggest that the user likely wants to next enter the “only” (in this model) valid text entry of “list accounts owned by users” choice 430. Although this is “clearly” the only valid choice at this stage, it is noted in reference to FIG. 3 that the user has many choices of targets that may be chosen following the selection shown in FIG. 4d. Accordingly, FIG. 4e shows that, indeed many relations connect to concepts and properties which have heretofore not been shown. Accordingly, a relation “who is” that relates “users” to “member” is shown. Further, since the number of options is limited, a further relation “of” associated with concept “teams” is also shown, as are other permutations following therefrom. This leads to FIG. 4f, in which the user has either typed, perhaps with the suggestions leading the way, perhaps by selecting various options, but nonetheless selecting a particular and known (to the invention) “valid” query consisting of the terms thus shown. It is noted that, as is the case here, a property or object may “require” the user to enter a “value.” Accordingly, further in this case, the query “list accounts owned by users who is member of teams named” is supplemented by the user with the value “sales”.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method of building a natural-language query, comprising:
associating an auto-complete menu system with a domain-specific concept model;
generating a command, by
detecting an active curser in a data query entry area,
displaying a list of proper commands, in a auto-complete fashion, to the user,
the list of proper commands comprising all elements of a set of proper commands consistent with any alphanumeric characters entered into the data query entry area,
detecting a command choice of the user, and displaying the command choice in the entry area upon determining that the command choice is a proper command; and
generating a target concept, by
displaying a list of proper concepts, in an auto-complete fashion, to the user,
the list of proper concepts comprising all concepts available to function as a target concept given the command choice,
detecting a concept choice of the user, and displaying that concept choice when the concept choice in the entry area is a proper concept.

2. The method of claim 1 wherein detecting the command choice determines the command by detecting sufficient typed alpha-numeric characters to limit the set of all proper commands to a single proper command.

3. The method of claim 1 further comprising detecting an improper command, informing the user that the command is improper, and displaying, in a auto-complete fashion, all the elements of a set of proper commands to the user.

4. The method of claim 3 further comprising accepting a command choice only if the command choice is an element in the set of proper commands.

5. The method of claim 1 wherein the list of proper commands is ordered based on historical queries, where the most commonly used proper command is listed first.

6. The method of claim 1 wherein the list of proper commands is ordered based on historical queries, where the most recently used proper command is listed first.

7. The method of claim 1 wherein detecting the concept choice determines the concept by detecting sufficient typed alpha-numeric characters to limit the set of all proper concepts to a single proper concept.

8. The method of claim 1 further comprising detecting an improper concept, informing the user that the concept is improper, and displaying, in a auto-complete fashion, all the elements of a set of proper concepts to the user.

9. The method of 8 further comprising accepting a concept choice only if the concept choice is an element in the set of proper concepts.

10. The method of claim 1 wherein the list of proper concepts is ordered based on historical queries, where the most commonly used proper concept is listed first.

11. The method of claim 1 wherein the list of proper concepts is ordered based on historical queries, where the most recently used proper concept is listed first.

12. The method of claim 1 wherein the word entry pattern and syntax is determined by a pre-selected minimally expressive grammar pattern.

13. The method of claim 1 further comprising generating a relation, by
determining the relations associated with a predicate (?) concept and related concepts and attributes;
displaying a list of proper relations, in a auto-complete fashion, to the user,
the list of proper relations comprising all relations that relate the predicate concept to another concept or attribute,
detecting a relation choice of the user, and displaying that relation choice when the relation choice in the entry area is a proper relation.

14. The method of claim 1 further comprising generating a comparitor, by
displaying a list of proper comparitors, in a auto-complete fashion, to the user,
the list of proper comparitors comprising all comparitors available to function as a comparitors given the prior-entered term,
detecting a concept choice of the user, and displaying that concept choice when the concept choice in the entry area is a proper concept.

15. The method of claim 1 further comprising generating a value, by
displaying a list of proper values, in a auto-complete fashion, to the user,
the list of proper values comprising all values available to function as a value given the prior-entered term,
detecting a value choice of the user, and displaying that value choice when the value choice in the entry area is a proper value.

16. A method of building a natural-language query, comprising sequentially:
associating a auto-complete menu system with a domain-specific concept model;
generating a command by detecting an active curser in a data query entry area, and displaying a list of proper commands, in a auto-complete fashion, to the user,
detecting a command choice of the user, and displaying the command choice in the entry area upon determining that the command choice is a proper command; and
generating a target concept, by
displaying a list of proper concepts, in a auto-complete fashion, to the user,
detecting a concept choice of the user, and displaying that concept choice when the concept choice in the entry area is a proper concept.

17. The method of claim 16 further comprising extracting data identified by a natural language query against a target database.
